(19) United States
(12) Patent Application Publication
(10) Pub. No.: US 2008/0294552 A1
(43) Pub. Date: Nov. 27, 2008

(54) Centralized Affiliated Marketplace Networks and Associated Methods

(75) Inventors: Matthew Kaufman, Redwood City, CA (US); John Dowd, San Jose, CA (US); Keith W. Teare, Palo Alto, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: LOOKSMART, LTD., San Francisco, CA (US)

(21) Appl. No.: 12/113,082

(22) Filed: Apr. 30, 2008

Related U.S. Application Data
(60) Provisional application No. 60/915,395, filed on May 1, 2007.

(51) Int. Cl. G06Q 30/00; G06Q 20/00; G06F 17/30; G06F 7/06

(52) U.S. Cl. 705/40; 705/34; 707/3; 707/E17.014

(57) ABSTRACT

A centralized marketplace for efficient and streamlined third party listings, including advertisements, to be placed within networks of marketplaces. An automated backend coordinates the submission of listing transactions, including the collection of fees, timings of display of listings, etc., as well as providing a platform to organize networks. Network organization may occur with user intervention or automatically by the automated backend by specifying a predetermined set of criteria. Each marketplace or marketplace network may facilitate the placement of listings in affiliated marketplaces and similarly receive listings from affiliates for a fee or free.

### CROSS-REFERENCE TO RELATED APPLICATIONS

The present application claims priority to U.S. Provisional Patent Application Ser. No. 60/915,395, filed on May 1, 2007.

### BACKGROUND

The patterns by which people receive information have been transformed since the use of the internet became widespread and throughout its evolution. Whereas once people consulted larger, general information sources, the trend today is to consult smaller, specialized information sources. Thus, the traffic to larger, general information sources is reduced today in favor of smaller, specialized information sources. Naturally, the owners of the smaller, specialized marketplaces seek to capitalize on listings revenues, but often lack the personnel and other resources to efficiently display listings in their marketplaces.

During the 1990's, the internet was dominated by large marketplaces. A marketplace is an online or offline venue that facilitates commerce and may range from large websites to small websites to offline print sources to individuals. Over the history of the internet, a gradual shift from large, varied content marketplaces to smaller, more specialized marketplaces has occurred. This shift, naturally, has led to a revitalization of ways in which content owners, such as advertisers, generate revenue. Many larger marketplaces are loosing traffic to the more specialized marketplaces, which has caused content owners to reevaluate how and where advertising money is spent.

At the same time, however, the more specialized marketplaces tend to be smaller operations. Often, these marketplaces are created, maintained, and run by individuals or small groups of individuals. Although the marketplaces generate increasing levels of traffic, the overall traffic is relatively small compared to the traffic of the larger marketplaces. Thus, small marketplaces often struggle to attract larger advertising revenues that reflect their increased traffic because these smaller marketplaces do not have the personnel and resources to create and implement extensive advertising schemes. Thus, small marketplaces, although attracting traffic that has traditionally gone to larger marketplaces, are often unable to capture advertising revenues that should follow the increased traffic to their marketplaces.

Moreover, small marketplaces tend to be specialized and exist with other small marketplaces specializing in the same or similar subject matter. The competing marketplaces often exist in niches that appeal to various groups of traffic, and often include subsets of the same users. These small marketplaces form niche communities, and the owners of the marketplaces tend to be aware of, and in some cases collaborate with, the other similar marketplaces in the niche communities.

### SUMMARY

A centralized marketplace for efficient and streamlined third party listings, including advertisements, to be placed within networks of marketplaces. An automated backend coordinates the submission of listing transactions, including the collection of fees, timings of display of listings, etc., as well as providing a platform to organize networks. Network organization may occur with user intervention or automatically by the automated backend by specifying a predetermined set of criteria. Each marketplace or marketplace network may facilitate the placement of listings in affiliated marketplaces and similarly receive listings from affiliates for a fee or free.

According to a feature of the present disclosure, there is disclosed a method comprising a first entity allowing a grouping of a plurality of second entities to receive a listing, the first entity receiving from a third entity content to generate a listing to be provided to the grouping, and the first entity providing the listing to the grouping.

Also disclosed according to a feature of the present disclosure is a method comprising a first entity collecting data from a plurality of second entities, the data comprising at least a fee to be paid to the second entity for receiving a listing from a third entity, the first entity allowing the third entity to generate a grouping based at least in part on the data, the first entity receiving from the third entity content to generate a listing to be provided to the grouping, the first entity providing the listing to the grouping, the first entity billing the third entity for allowing the third entity to generate the grouping, generating the listing, and providing the listing to the grouping, and providing for each second entity the fee to be paid the second entity for receiving the listing from the third entity.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a block diagram of an embodiment of a method of using a centralized listing backend;

FIG. 2 is a block diagram of an embodiment of an affiliate system that may be used in conjunction with the centralized listing backend of the present disclosure;

FIG. 3 is a block diagram of an embodiment of a marketplace network that allows a content owner to simultaneously distribute a submitted listing throughout the marketplace network;

FIG. 4A is a flow diagram of an embodiment of a method of distributing listings using a centralized listing backend; and

FIG. 4B is a flow diagram of an embodiment of a method of distributing listings over a marketplace network using a centralized listing backend; and

FIG. 5 is a block diagram of an embodiment of a method of submitting listings to a marketplace individual.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

According to the present disclosure, the terms “listing” and “advertisement” may be used interchangeably. Similarly, the term “content owner” may be used interchangeably with the term “advertiser.” Finally, the term “first entity” may be used interchangeably with the term “centralized listing backend.”

In accordance with one embodiment, a centralized listing backend can utilize economics of scale to provide the resources for small marketplaces to earn revenue from listings, defined as content generated by parties independent of a particular marketplace with less expense and investment of energy. A marketplace is an online or offline venue that facilitates commerce and may range from large websites to small websites to offline print sources to individuals. Moreover, by using a centralized backend for listings, content owners, or people, groups of people, or organizations that submit content to a marketplace, may place listings at a single small marketplace and propagate the listing to other marketplaces. In addition, in one embodiment, smaller unique communities can be used as a platform to disseminate certain listings to a larger audience, which helps content providers more effectively place listings based on trends in the marketplace traffic.

Although one embodiment of the present disclosure is suited for smaller marketplaces, it is equally suited to be used with larger marketplaces to increase the visibility of their listings, in both online and traditional marketplaces, such as magazine and newspaper classifieds. Thus, the present disclosure provides a system and methods to centralize placement of listings. Content owners may therefore follow changes in marketplace traffic patterns, even where the traffic is diverted to small marketplaces where alone, the level of traffic may not justify placement of marketplace content, which are listings submitted by the content owner.

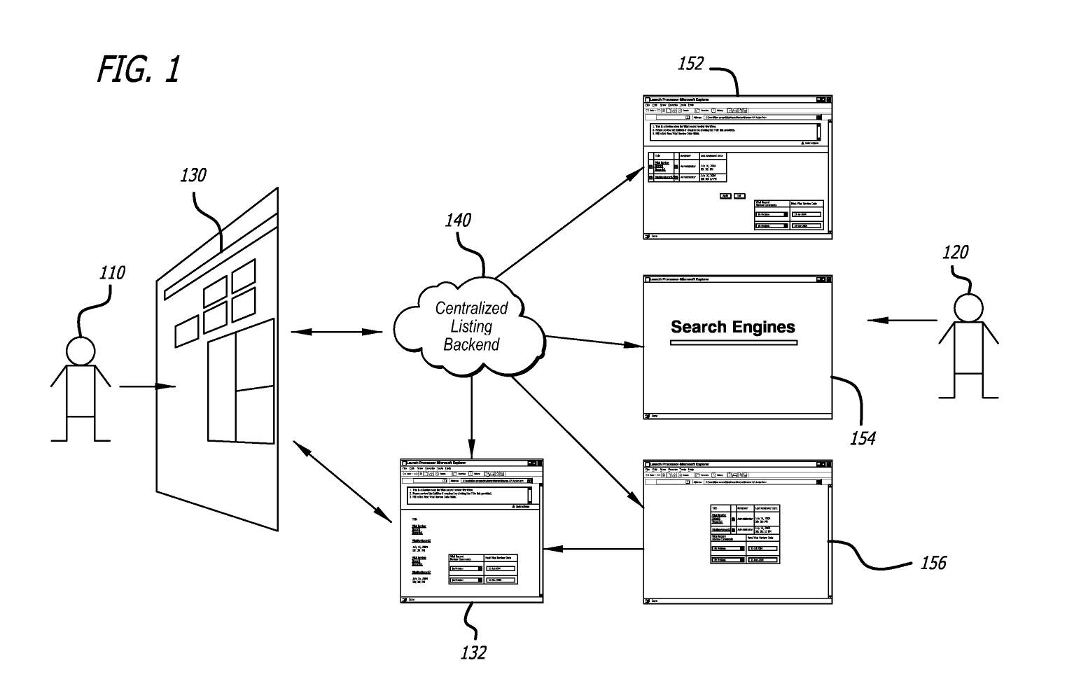

Turning to an embodiment in FIG. 1, marketplaces 130 may be both online or offline, as would be known to artisans. Online marketplaces may be online classified systems, of varying sizes, general or specific content websites, weblogs, commercial websites, and any other online resource where content owners are permitted to submit listings. Offline marketplaces, according to one embodiment, may be traditional print media, such as classified advertisements, newspapers, and magazines. Marketplaces may also comprise radio and television advertising, according to embodiments, as well as individuals, such as a person's cell phone or computer system.

According to an embodiment shown in FIG. 1, a marketplace owner creates marketplace 130. According to one embodiment, marketplace 130 may be a website dedicated to publishing listings 132, or it may be a website dedicated to another purpose where advertising serves a role in conjunction with the other functions and features of given marketplace 130. For example, marketplace 130 may solely comprise a collection of classified listings 132 of boats. Similarly, marketplace 130 may comprise content related to boats including articles, discussion forums, and boating getaways, where advertising of boats is provided to the traffic visiting for the other features of marketplace 130.

Marketplace owners 110 define their marketplace 130. According to one embodiment, marketplace owners determine the type or classification of content permitted on their marketplace 130. The content and other materials found on marketplace 130, including the subject matter are therefore defined by the marketplace owner and the contributors to marketplace 130. In one embodiment, a centralized listing backend 140 provides the engine for submission and display of listings 132 and may be used to coordinate the subject matter of listings 132 with the subject matter of marketplace 130 to provide consistency of subject matter.

According to one embodiment, marketplace owner defines the behavior of centralized listing backend 140 as it applies to their marketplace 130. According to one embodiment, marketplace owners may define the types or categories of goods or services that may be offered on marketplace 130 via listings 132. Thus, the marketplace owner can restrict the goods and services advertised to match the subject matter of marketplace 130, thereby increasing the value of advertising “real estate” on marketplace 130 by providing more productive marketplace content, which makes marketplace 130 more desirable to content owners 110 wishing to place listings 132 offering goods and services related to the subject matter of each marketplace 130.

Moreover, marketplace owners may define the layout and scheme of listings 132 posted to their marketplace 130. According to one embodiment, marketplace owners may supply cascading stylesheets (CSS) or customized HTML, images, and colors to define to look and feel of listings 132, as known to artisans. Listings 132 are hosted by centralized listing backend 140, which applies a marketplace owner's look and feel of listing 132 according to one embodiment. Thus, marketplace owners may duplicate the look and feel of marketplace 130 irrespective of where listing 132 is hosted. Marketplace owners may define fonts, colors, layouts, background images, and so forth of the listing.

According to one embodiment, marketplace owners may define portions of each marketplace 130 webpage for display of listings 132 instead or in addition to a dedicated page (see FIG. 1). Using a JavaScript or Flash widget, for example, listings 132 may be displayed in predefined areas of marketplace 130, e.g., a banner or box of predetermined size, by retrieving from centralized listing backend 140 listings 132. Listings 132 retrieved will be defined by CSS or other similar methods of formatting the look and feel of the smaller listing real estate on marketplace 130.

According to similar embodiments, marketplace owners may host listings 132 by receiving syndication feeds of relevant listings 132. For example, listings 132 may be published and syndicated using an XML feed, such as a really simple syndication (RSS) feed, atom feed, or equivalents, and display listing 132 in marketplaces hosted by the marketplace owner. According to these embodiments, marketplace owners control all aspects of the look and feel of the marketplace. In one embodiment, these principles extend to offline marketplaces.

Marketplace owners may also define in centralized listing backend 140 administrative features of marketplace 130, according to one embodiment. Marketplace owners may define fees to be paid by content owners 110 submitting listings 132. These fees may be flat fees, cost per click fees, or cost per action fees, according to one embodiment. Artisans will recognize the various fee collection fees that may be used in conjunction with internet advertising and that may be implemented in conjunction with the present disclosure. Similarly, marketplace owners define the type of content, such as text, graphical marketplace content, classifieds, and so forth to be submitted, the length of time each listing 132 will persist in marketplace 130, the number of listings 132 that are permitted on marketplace 130 at any given time, the ways in which listings 132 expire from marketplace 130, and so forth. According to one embodiment, the marketplace owner may also define whether marketplace 130 hosts an affiliate program and accepts listings 132 for other marketplaces 130 or marketplace networks. Additionally, according to one embodiment, marketplace owner may select additional features such as textual decorations that are permitted for listings 132, as well as premium content and placement of listings 132. The feature set available to marketplace owners may vary with the implementation of centralized listing backend 140.

Marketplace 130 is administered by centralized listing backend 140. A content owner 110 visits marketplace 130 to post listing 132. Using a javascript widget or flash widget, provided by centralized listing backend 140, for example, content owner 110 submits listing 132. The widget allows content owner 110 to submit listing 132 to centralized listing backend 140 directly from marketplace 130. According to one embodiment, however, content owners 110 may visit centralized listing front-end 156 to submit listings 132, as well. From centralized listing front-end 156, content owner 110 may select one or more marketplaces 130 to submit listing 132.

Referring still to FIG. 1, centralized listing backend 140 may publish listings 132 to ancillary marketplaces 152, as well as make listings generally available to search engines 154. According to one embodiment, listing 132 is posted to centralized listing backend 140. Centralized listing backend 140 may then make listings generally available to be searched via centralized listing front-end 156 or via search engines 154, which serve as ancillary marketplaces together with other marketplaces to which the listing is propagated to. According to one embodiment, search engines 154 may be general search engines or specialized search engines. Moreover, search engines 154 may be search engines dedicated to a given subject matter, according to one embodiment. Integration with search engines 154 and ancillary marketplaces and publishers 152 may be accomplished by providing XML feeds to the relevant marketplaces. XML feeds may comprise syndication feeds, such as RSS or Atom feeds, or may be proprietary, depending on the implementation of the feeds.

According to the embodiment shown in FIG. 1, listings 132 are hosted by centralized backend server 140. When consumer 120 investigates listing 132 link from marketplace 130, consumer 120 is directed to a listing 132 webpage hosted by centralized listing backend 140. Because marketplace owners will generally configure listing 132 to mirror the look and feel of marketplace 130, most users will be unaware when viewing listing 132 that they are no longer viewing content on marketplace 130, but rather content provided by centralized listing backend 140.

Similarly, consumers investigating links to listings 132 from ancillary marketplaces and publishers 152, search engines 154, or centralized listing front end 156 will be directed to listing 132. Listing 132 will be made up with data inputted by content owner 110 during submission of listing 132. All links in listing 132 webpages will direct consumer 120 to marketplace 130, according to one embodiment. For example, a user may search centralized listing backend and select listing 132 from a set of results. Selecting listing 132 will take the user to listing 132 page hosted on centralized listing backend 140 which duplicates the look and feel of marketplace 130 where listing 132 was originally submitted. Conversely, where listing 132 is selected on different marketplace 130 where listing 132 was not originally submitted, listing 132 page displayed will mimic the look and feel of different marketplace 130, but with an annotation indicating that the item was published on marketplace 130 where it was originally published. The look and feel of each particular listing 132 varies case by case according to the various circumstances of the display of each listing 132.

Some marketplaces 130, according to one embodiment, will display listing 132 as a portion of the content of marketplace 130, as previously described. According to one embodiment, marketplaces 130 may be embedded with javascript widgets, for example, which pull listing 132 from centralized listing backend 140 and display listing 132 as an embedded portion of the overall content of marketplace 130. According to the exemplary embodiment, listing 132 may comprise a banner or other dedicated marketplace 130 real estate that displays listing 132 content hosted by centralized listing backend 140.

According to one embodiment and as previously described, listings 132 may be hosted as part of the content of marketplace 130 by the marketplace owner. Marketplace owners may implement their own marketplace listings using XML feeds as previously described and as known by artisans.

As previously described, small, subject specific marketplaces tend to be familiar with other marketplaces offering similar content subject matter. Content owners that target the traffic of small, subject specific marketplaces stand to benefit from propagating a listing to a group of similarly situated marketplaces rather than visiting each to submit listing 132.

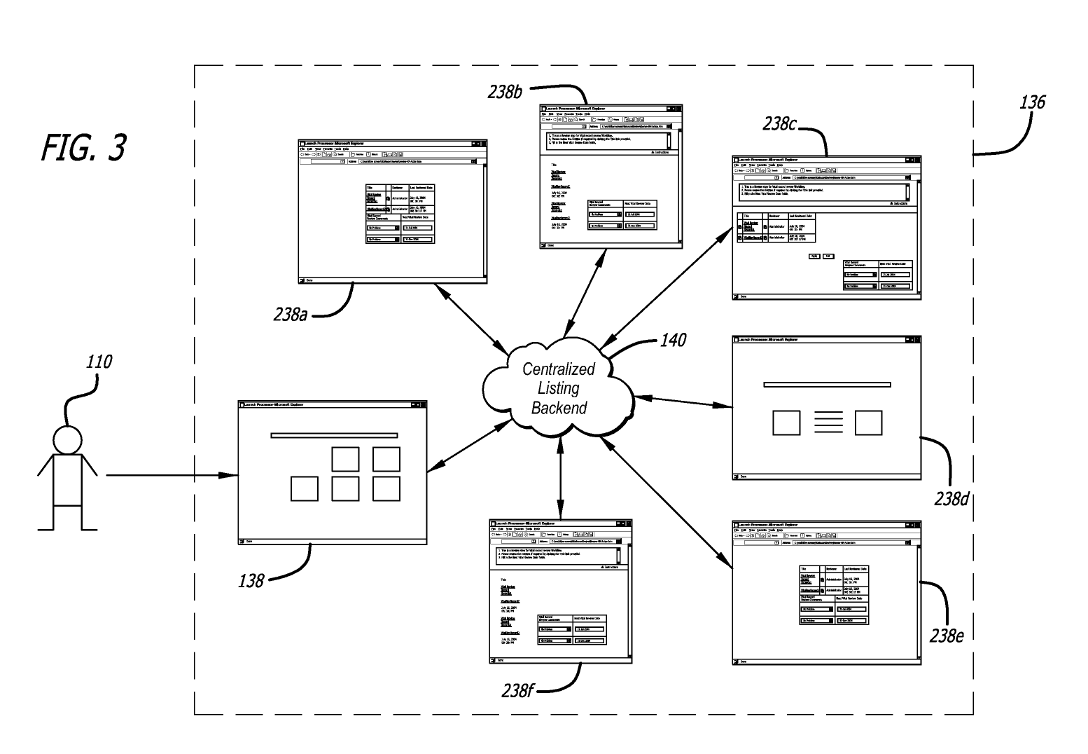

As shown in FIG. 3, content owners 110, 112 may propagate listings 132 (see FIG. 1) to multiple marketplaces 130, 134 by visiting single marketplace 134 or a small subset of marketplaces 130, 134 where the content owners 110, 112 wish to submit listings 132. Centralized listing backend 140 provides a platform for propagation of listing 132 from marketplace 134 to marketplace 130, as shown in an exemplary embodiment of FIG. 3. According to one embodiment, marketplace owners receive a portion of revenues when listing 132 is propagated to their marketplace 130 from another marketplace 134.

According to an embodiment shown in FIG. 3, content owner 110 may submit listing 132 to a single marketplace 130. Marketplace owner, as part of the process of creating marketplace 130, will decide the payment structure for content owner's submission of listing 132. The payment structure, as previously described, may be any payment structure known to artisans for advertising goods and services online or offline, to which the principles of the present disclosure apply. For example, marketplace owner may charge content owner 110 based on a flat fee, cost per clicks (CPC), or cost per action (CPA), or real estate occupied by listing 132, according to one embodiment.

For example, marketplace owner decides that marketplace content placed by content owners 110 on marketplace 130 will cost $200 for a week. Marketplace 130 is dedicated to sailboats, and contains articles relating to sailing, product reviews, America's Cup information, and other features of interest to sailors. Content owner 110 is a sailboat parts manufacturer and wishes to sell sailboat accessories. Content owner 110 chooses to place listing 132 to sell sailboat accessories on marketplace 130. Content owner 110 visits marketplace 130 to submit listing 132. Content owner 110 is directed to a form or other submission method, as would be known and understood by artisans.

Submission of listing 132 is made and ultimately submitted to centralized listing backend 140. Centralized listing backend 140 receives listing 132 and charges content owner 110 for placement of listing 132 and receives revenue 200, according to one embodiment. Centralized listing backend 140, according to one embodiment, retains a portion of revenue 200. Indeed, the services of centralized listing backend 140 may rely solely on retaining a portion of revenues 200 for listings 132 posted to marketplaces 130 according to one embodiment.

Marketplace owner, according to the embodiment, receives revenue 200 collected by centralized listing backend 140 less any portion of revenue retained by centralized listing backend 140. Thus, marketplace owner may use centralized listing backend 140 to increase revenues by inducing placements of listings 132 without the need to maintain a marketplace backend to handle listings 132, including submission of the listings, display of the listings, timing of displays, expiry of listings, etc., and payment of revenue for each listing 132 submitted.

Referring still to embodiments shown in FIG. 3, content owners 112 may also submit to a plurality of marketplaces 130, 134 in a single step by submitting listing 132 to single marketplace 134 and propagating listing 132 to other marketplaces, for example to marketplace 130. For the purposes of the discussion below, marketplace 130 will be understood to represent at least one marketplace where listing 132 is propagated.

According to one embodiment, content owner 112 may wish to submit listing 132 to a number of related marketplaces 130, 134. Centralized listing backend 140 provides a framework to submit listing 132 to single marketplace 134 and propagate listing 132 to a plurality of marketplaces, for example marketplace 130. Propagation can occur to a virtually unlimited number of marketplaces, provided the marketplaces are connected to centralized listing backend 140.

Centralized listing backend 140 handles propagation of listings 132, according to one embodiment. Because centralized listing backend 140 hosts listing 132 (see e.g., FIG. 1), each marketplace 130, 134 where listing 132 is submitted or propagated by centralized listing backend 140 need only be configured with a javascript widget to have listings 132 displayed, according to one embodiment. Where marketplace 130, 134 directly hosts listings 132, listings 132 submitted via other marketplaces may be received via XML feed, as previously described.

According to one embodiment, revenues 202 are generated for the marketplace 134 where submission of listing 132 occurs as previously described. According to one embodiment and as shown in FIG. 3 via dashed lines, which shows the how payment occurs when the listing is originally submitted to marketplace 134 and propagated to marketplace 130. Naturally, for content owner 112 to place listing 132 with both marketplace 134 and marketplace 130, content owner 112 must pay the fee to place listing 132 with each marketplace 130, 134. Because marketplace owners set their own revenue structures, content owners may be obligated to pay different fees or participate in different fee arrangements from marketplace to marketplace. A marketplace may charge a flat fee of $200 to place the listing for a week and another marketplace may charge $0.05 per click on listing 132, for example. Centralized listing backend 140 will collect fees from content owners 110, 112 based on the parameters defined by the marketplace owner for each marketplace 130, 134 where listing 132 is published.

Additionally, according to one embodiment, marketplace owners may create an affiliate-type program to provide incentives to other marketplace owners to propagate listings 132 placed on their marketplaces 134 to marketplaces 130, so that marketplace 130 may also earn listing 132 submission fees. As referred to earlier, small, specialized content marketplaces tend to be aware of similar marketplaces. Moreover, content owners 112 are less inclined to place listings at single, small marketplaces with limited traffic, but more inclined to place listings with a number of similar marketplaces to increase the number of viewers of their listings 132. Thus, marketplace owners are in position to point content owners 112 to other marketplaces 130 to increase the traffic potentially viewing their listings 132, thereby bring content owners 112 to their marketplace 134 by providing the incentive of connecting content owner 112 with similar marketplaces. Thus, content owners 112 may submit listing 132 at single marketplace 134 and choose to propagate listing 132 to similar marketplaces 130, without visiting each one or even being aware of the existence of the other marketplaces 130 before visiting marketplace 134.

According to one embodiment, content owner 112 submits listing 132 via marketplace 134. Each marketplace owner may decide whether to participate in the affiliate-type program and the affiliates that will be offered to content owners 112 for listing 132 propagation during submission to marketplace 112, according to one embodiment. Marketplace owners, according to further embodiments, decide the affiliate fee they will pay for listings propagated to their marketplace 130 as part of participation in the affiliate type program.

According to one embodiment, during the listing submission process, content owner 112 may be presented with an option to propagate listing 132 to marketplaces 130 other than marketplace 134 on which content owner 112 is directly submitting listing 132. According to further embodiments, owner of marketplace 134 will have discretion as to which affiliate marketplaces 130 are presented to content owner 112. Consequently, if owner of marketplace 134 does not want to propagate listings 132 submitted via marketplace 134 to marketplaces 130 that do not pay an affiliate fee or that marketplace owner does not want to drive content owners 112 to, the marketplace owner may omit them from the marketplaces to which content owner 112 may elect to propagate listing 132. Furthermore, owner of marketplace 134 may choose not to affiliate with any other marketplace; consequently, content owner 112 will be unable to propagate listing 132 to other marketplaces 130 from marketplace 134. Centralized listing backend 140 handles propagation and interaction with content owner 112 regarding propagation choices, according to one embodiment.

As exemplified in FIG. 3, content owner 112 submits listing 132 to marketplace 134. During the submission process, content owner 112 is offered a choice of affiliates with which to propagate listing 132. According to one embodiment, centralized listing backend 140 coordinates which marketplaces, for example marketplace 130, are offered to content owner 112. The offered choice of affiliates may detail various information about each affiliate including the price to list with the affiliate and other useful information, such as a summary of the subject matter offered at marketplace 130. In one embodiment, additional information is offered to a content owner 112 in conjunction with the decision as to which marketplaces to propagate listing 132.

Content owner 112 selects affiliates to which content owner 112 wishes to propagate listing 132. Content owner 112 may select, in addition to submission of listing 132 to marketplace 134, to have central listing backend 140 propagate listing to affiliated marketplaces 130. Although content owner 112 submits listing 132 directly only through marketplace 134, centralized listing backend propagates listing 132 to affiliated marketplaces selected by content owner 112, such as marketplace 130. Content owner 112 must then pay revenues to each marketplace 134, 130 that content owner 112 either directly submits listing 132 to or chooses to have listing 132 propagated to, represented in FIG. 3 by the dashed line as revenue 202 and revenue 200. Marketplace 134 may receive an affiliate fee from affiliated marketplace 130 for referring listing 132 to affiliated marketplace 130. Revenues are collected by centralized listing backend 140 and distributed to the owner of each marketplace.

For example, for submitting listing 132 to marketplace 134, revenue 202 is collected by centralized listing backend 140 and redistributed to the owner of marketplace 134. The revenue would comprise the listing fee revenue 202 less any portion of revenue 202 retained by centralized listing backend 140. For propagating listing 132 to affiliated marketplace 130, the owner of marketplace 134 may receive an affiliate fee. The affiliate fee may be determined by affiliated marketplace 130 or by marketplace 134, according to various embodiments and is added to revenue 202 that is paid to the owner of marketplace 134. Additionally, centralized listing backend 140 may retain a portion of revenue 200 to be paid to the owner of marketplace 130. Thus, revenue 200 paid to affiliated marketplace 130 owner will be gross revenue 200 less the affiliate fee paid to marketplace 134 owner and the portion retained by centralized listing backend 140.

For example, a sail manufacturer wishes to submit listing to a general boating marketplace for a flat fee of $200 for one week. However, the sail manufacturer also wishes to increase sales by submitting listings to other marketplaces dedicated to boating, particularly sailboating. During the submission process of the sail manufacturer's listing, sail manufacturer is presented with an option to propagate the listing to a dedicated sailboat marketplace for an additional $225. The sailboat marketplace offers a $25 affiliate fee for referral of advertisers. The sail manufacturer selects both the general boating marketplace and the sailboat marketplace to submit and display a listing for custom-made sails.

Thus, because the custom-made sails listing is submitted to the general boating marketplace, the general boating marketplace earns a gross revenue of $200. Similarly, because the sail manufacturer elected to propagate the custom-made sales listing to the sailboating marketplace, the sailboating marketplace makes a gross revenue of $225. However, the centralized listing backend retains $50 of the gross revenue of each transaction. Additionally, the sailboating marketplace pays the general boating marketplace the $25 affiliate fee.

Consequently, for having the listing displayed for one week at both marketplaces, the general boating marketplace is paid $175 ($200 gross revenue−$50 centralized listing backend fee+$25 affiliate fee paid from the sailboating marketplace). The sailboating marketplace is paid $150 ($225$50 centralized listing backend fee−$25 affiliate fee paid to the general boating marketplace).

Centralized listing backend 140 automatically calculates the fees owed to each marketplace 130, 134, according to one embodiment. Consequently, affiliate fees are not paid directly from marketplace 130 to marketplace 134, but rather centralized listing backend 140 calculates and adjusts revenues 200, 202 to reflect the amount owed to each marketplace 130, 134. Content owners 110, 112 tender payment in one of several ways, as well as revenues 200, 202 are dispersed to the marketplaces 130, 134 in one of several ways.

In one embodiment, centralized listing backend 140 screens listings and only permits propagation to marketplaces 130, 134 suitable for the listings. Thus, referring again to the boat example, a water ski company would be permitted to submit listing to the general boating marketplace. However, according to one embodiment an option to propagate the listing to the sailboat marketplace would not be presented, as water skis are not used with sail boats. According to other embodiments, if listing 132 is unsuitable for a single marketplace that is offered to content owner 112 among a group of affiliates during the submission process of listing 132, content owner 112 may be precluded from propagating listing 132 altogether.

According to still similar embodiments, marketplace owner 130 precludes having listing 132 listed on their marketplace 130, regardless of the origin. Thus, marketplace owners 110 retain control over the content of their marketplaces 130, despite the ability of content owners 112 to propagate listing 132 to marketplace owner's 110 marketplace 130. Likewise according to other embodiments, marketplace owner 112 similarly precludes listing 132 that is submitted directly to their marketplace 134.

### Market Place Networks

According to one embodiment and as shown in FIG. 3, marketplace owners may also aggregate into marketplace networks 136, which comprise a collection of compatible marketplaces 138, 238a-f. Use of a marketplace networks 136 allows content owners 112 to place listing in all marketplaces 138, 238a-f in marketplace network 136 without the need to place listing in marketplace 138 and thereafter select other marketplaces to propagate listing.

According to one embodiment, content owners 110 pay a single price to propagate listing to all marketplaces 138, 238a-f belonging to marketplace network 136. Distribution of fees paid to marketplace network 136, according to one embodiment, are determined based on the terms of the relationship between marketplaces 138, 238a-f and marketplace network 136. According to similar embodiments, marketplace network 136 will participate in each marketplace 138, 238a-f affiliate program. If the terms of a given marketplace's affiliate program are incompatible with the terms of marketplace network 136, that particular marketplace will not join marketplace network 136 unless a different agreement is made, according to one embodiment.

Marketplace network 136 is, according to one embodiment, created on centralized listing backend 140. Each marketplace network 136 comprises a defined set of business terms, according to one embodiment. Business terms of the marketplace network may be the same or similar to the type of business terms defined on a marketplace within the marketplace network, or may comprise different terms.

To form marketplace network 136, according to one embodiment, marketplace network 136 owner may register with centralized listing backend 140. Marketplace network 136 owner creates marketplace network 136 and invites marketplaces 138 to join marketplace network 136. Marketplaces invited to join marketplace network may include a particular marketplace owned by marketplace network owner among other marketplaces or may comprise only marketplaces not owned by marketplace network owner.

According to one embodiment, when a marketplace owner receives an invitation to join marketplace network 136, the invitation includes a proposal for the business terms between that marketplace owner and marketplace network owner. These terms define the relationship between marketplace network owner and marketplace owner, for example, how monies collected when listing is submitted are dispersed between marketplace 138, 238a-f and marketplace network 136. According to one embodiment, affiliate fee terms may be used as part of the terms or marketplace network owner and marketplace owner may negotiate different terms. According to one embodiment, marketplaces 138, 238a-f may be configured to automatically join invitations from marketplace network 136 when a threshold level of one or more terms are met by marketplace network's 136 invitation.

Similarly, according to one embodiment, marketplace network owners may invite marketplaces to join marketplace network 136. As part of this process, terms are presented and both marketplace and marketplace network 136 will have an opportunity to accept the terms of the relationship. If either party does not accept the terms or modifies the terms as presented, both parties must agree to the same terms for the relationship to form. According to one embodiment, marketplace owners belonging to marketplace network 136 may invite other marketplaces to join marketplace network 136; according to one embodiment, a finders fee may be paid for inviting additional marketplaces to join.

The relationship between each marketplace 138, 238a-f and the respective marketplace network 136 to which it belongs may be terminated at any time by either party or as defined by the terms. Listings that were submitted while the relationship between marketplace 138, 238a-f and marketplace network 136 existed will be honored as if the relationship continued to exist, according to one embodiment, if the relationship dissolved after the listing was submitted.

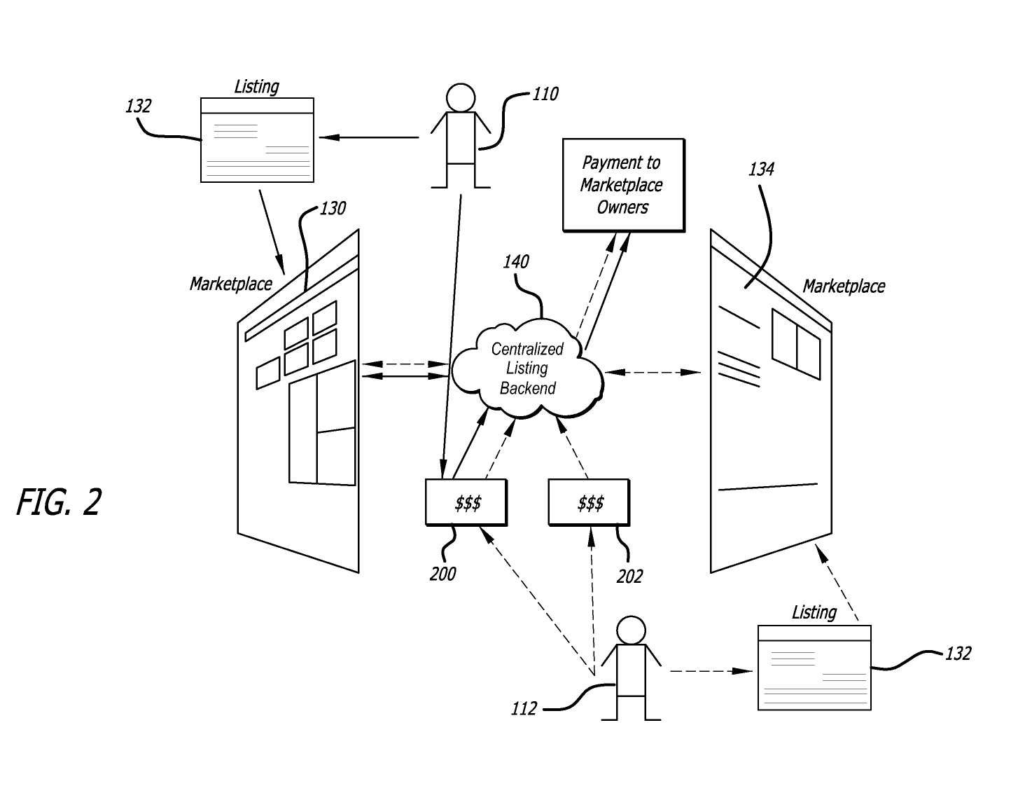

When listing is posted to marketplace network 136, the listing is automatically propagated to each marketplace 138, 238a-f belonging to marketplace network 136, according to one embodiment. Similarly, when the listing is placed with marketplace 138 as previously described, content owner 112 may select to propagate listing 132 to affiliated marketplaces 130, 134 (See FIG. 3) or to marketplace network 136. According to one embodiment, marketplace network 136 may be listed in a list of affiliated marketplace 130, 134 (FIG. 2) to propagate listings.

According to one embodiment, marketplace networks 136 are defined by statistics or metadata. For example, given marketplace network 136 may be defined by metadata including the number of marketplaces 138, 238a-f that belong to given marketplace network 136, the number of visitors accessing marketplaces 138, 238a-f that are part of given marketplace network 136, the number of unique users attracted in a time period to marketplaces 138, 238a-f that are part of a given marketplace network 136, the number of views and unique viewers of particular listings, etc. Similarly, according to one embodiment, if marketplaces 138, 238a-f are defined by particular metadata (i.e., geographic information, age range targeted by marketplace network 136, income of people attracted to particular marketplaces 138, 238a-f etc.), that metadata may be used to further define marketplace network 136. According to one embodiment, these data are collected as each marketplace 138, 238a-f joins marketplace network 136 or on an ongoing basis.

According to one embodiment, situations may arise where marketplace network 136 will be attractive to so many marketplaces that marketplace network 136 owner cannot practically evaluate and invite all suitable marketplaces to join marketplace network 136. Centralized listing backend 140, according to one embodiment, provides an automated mechanism to add marketplaces to marketplace network 136. According to the embodiment, marketplace network 136 owner defines the type of marketplaces that are suitable for marketplace network 136. Additionally, further parameters may be defined such as cost, geography, individual demographics, etc. Centralized listing backend 140 then identifies marketplaces that are eligible to join marketplace network 136 based on the metadata or other similar evaluation criteria of each marketplace 138 and the selected marketplaces to join marketplace network 136.

Similarly, according to one embodiment, centralized listing backend 140 provides one or more tools for allowing marketplace network owner to set the criteria marketplaces must meet to join marketplace network 136. For example, “sliders” may be provided to allow marketplace network owners to easily set the relevant joining criteria. When marketplace network owner adjusts the sliders for each parameter, centralized listing backend 140 generates the appropriate data automatically that define marketplace network 136. For example, a slider is provided for cost, geography, age, etc. Each slider defines a range for the given parameters. For example, the cost range may start at $0.01 and end at $1,000. If marketplace network 136 is created for marketplaces specializing in used automobiles, a cost slider could be positioned by marketplace network owner at or near $1,000, precluding marketplaces or listings that deal predominantly with car accessories under $1,000 in price.

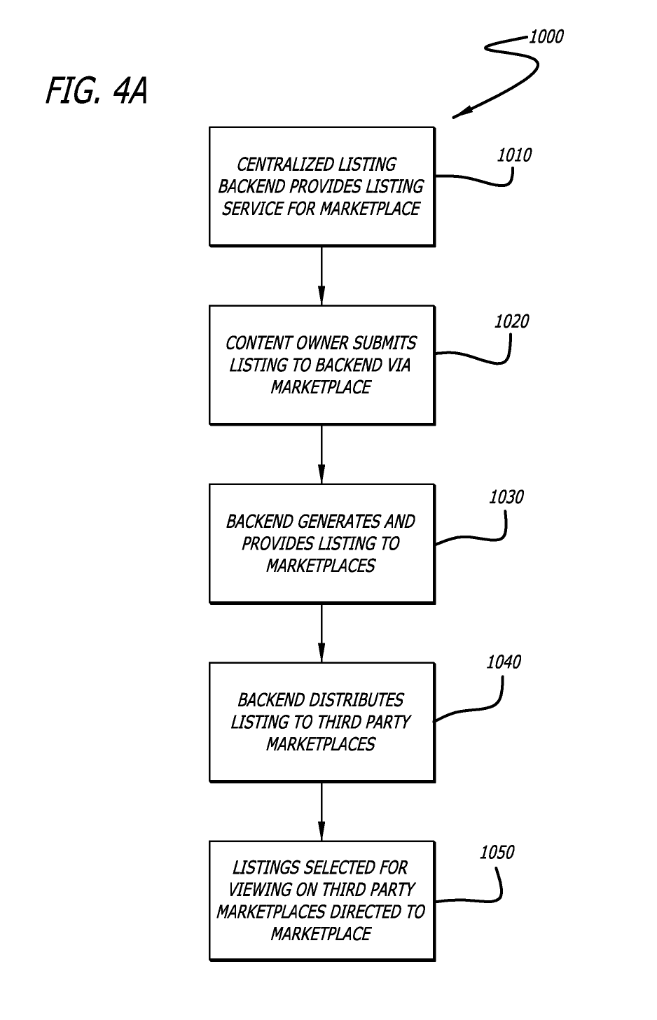

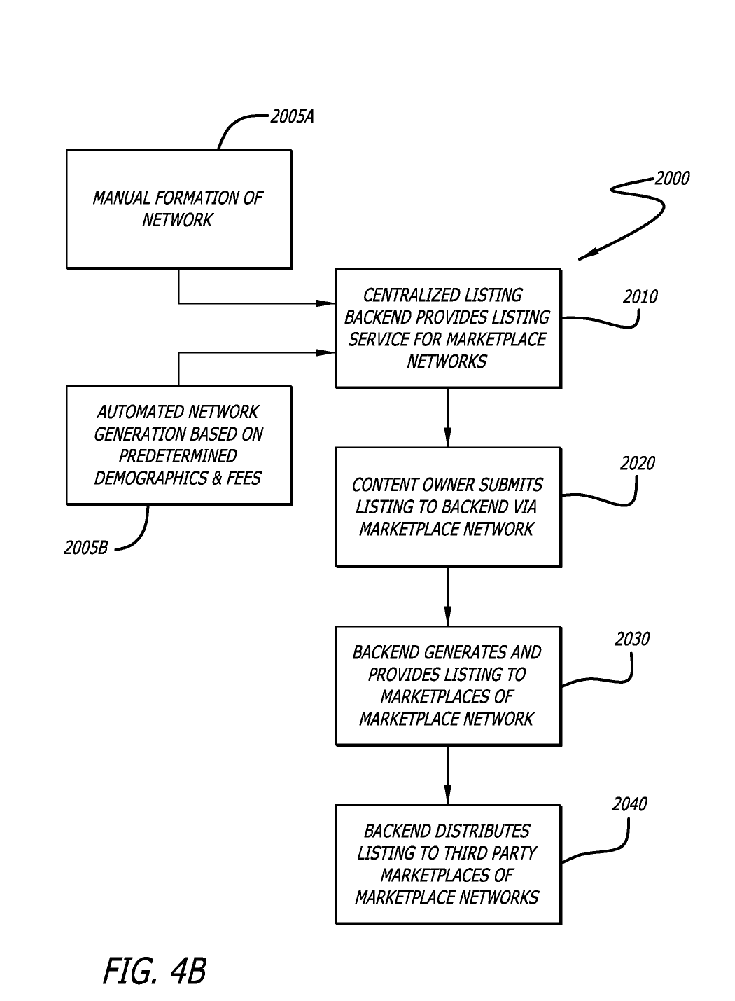

FIGS. 4A and 4B illustrate embodiments of a method for implementing marketplaces and marketplace networks. As disclosed herein, marketplaces may exist independent of networks or as part of a marketplace network. When a marketplace is not part of a marketplace network, it may still be affiliated with one or more other marketplaces and have listings submitted to affiliated marketplaces propagated to it to earn revenues.

According to one embodiment illustrated in FIG. 4A, listing system 1000 includes a centralized listing backend to provide a listing service for marketplaces 1010. Marketplaces subscribe to the centralized listing backend to handle placement of listings instead of handling the listings locally, as disclosed herein. Content owners then submit listings to selected marketplaces via the centralized listing backend 1020. The centralized listing backend receives the listings and, based on criteria determined for each marketplace, formats and provides the listing to the marketplace 1030. According to one embodiment, users will be unable to differentiate between the marketplace and the listing content shown and hosted on the centralized listing backend. The centralized listing backend also distributes the listing to third party marketplaces 1040, as selected by the content owner or as default setting of the centralized listing backend (e.g., making the listing available to users who perform searches directly on centralized listing backend). Listings which are selected for viewing on third party marketplaces are then optionally referred back to the originating marketplace, according to one embodiment 1050.

As illustrated in FIG. 4B, marketplace network listing system 2000 operates similarly. According to an embodiment, centralized listing backend provides a listing service for marketplace networks 2010. Centralized listing backend provides a platform for organizing marketplace networks. Prior to listings being submitted to a marketplace network, each marketplace network must be created. Marketplace networks comprise a plurality of marketplaces. As such, a marketplace network may be manually formed by a marketplace network owner as described herein 2005A by inviting a group of marketplaces to join under a predetermined set of terms, according to one embodiment. Alternatively, according to one embodiment, marketplace network may be formed by an automated process 2005B. The automated process allows the marketplace network creator to specify one or more demographics and centralized listing backend forms the marketplace network based on the specified demographics.

After a marketplace network is formed 2005A, 2005B, listings may be submitted to it 1020. As previously described, content owner submits a listing to centralized listing backend 1020. The centralized listing backend generates the listing 1030 and distributes the listing to each marketplace belonging to the marketplace network 1040.

### Marketplace Individuals

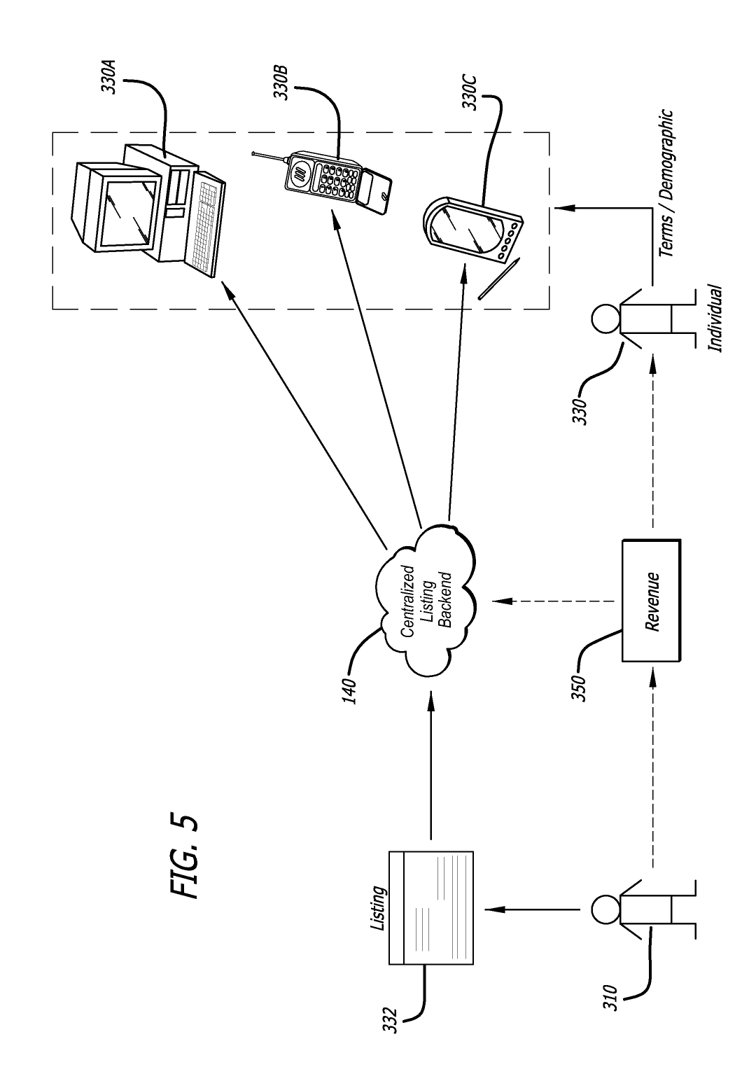

Referring to FIG. 5, according to a similar embodiment, individuals may also be marketplaces. Marketplace individual 330 may comprise, for example, an email address, an operating system desktop widget 330A, a cellular phone platform 330B, a personal digital assistant 330C, a telephone number, etc. Indeed, marketplace individual 330 may comprise communication mediums wherein an individual is the final recipient of the communication. Various communications mediums that an individual uses may therefore be used as marketplace. Like larger marketplace owners, marketplace individual 330 may set the terms in which listings may be propagated to marketplace individual 330. For example, marketplace individual 330 may permit telemarketers to call their phone number for a fee, for example $0.50 per call. Similarly, marketplace individuals 330 may define the listings 332 that are permitted and those that are not permitted.

According to one embodiment as shown in FIG. 5, the same parameters may be specified by marketplace individual 330, where applicable, as previously described. Additionally and according to one embodiment, marketplace individuals 330 may comprise additional or different data as part of the metadata associated with marketplace 330, which provides information to content owners 310 and allows content owners 310 to make educated choices regarding whether to publish listings 332 on each marketplace individual 330. According to one embodiment, these data comprise at least demographic data, for example age group, gender, geography, etc., which are useful to content owners 310 for the purposes of targeting a selected audience. According to one embodiment, centralized listing backend 140 provides a platform for distribution of revenues 350 to marketplace individual 330 and for receiving content and payment from content owners 310, where appropriate.

Marketplace networks 136 (see FIGS. 2, 3) provide an effective platform for reaching these marketplace individuals 330. For example, content owner 310 may be a marketing firm that creates marketplace network 136 for the purpose of distributing email advertisements to marketplace individuals 330. The marketing firm decides to target any marketplace individual 330 who will accept email advertisements for $0.05 or less, based on the defined terms and demographic data provided by marketplace individual 330. According to one embodiment, centralized listing backend 140 would use the automated evaluation and invitation feature to target marketplaces individuals 330 meeting the selected criteria. Similarly, additional data could similarly be evaluated by the marketing firm and automatically used to target more narrow combinations of parameters. For example, the marketing firm may be sending an email advertisement for a new video game that would be attractive to teenaged young men. The marketing firm could use parameters to create marketplace network 136 to target multiple parameters of marketplaces individuals 330: gender, age group, and those that will accept email advertisements for $0.05 or less.

The process described above can be stored in a memory of a computer system as a set of instructions to be executed. In addition, the instructions to perform the processes described above could alternatively be stored on other forms of machine-readable media, including magnetic and optical disks. For example the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSIs), application-specific integrated circuits (ASICs), firmware such as electrically erasable programmable read-only memory (EEPROMs); and electrical, optical, acoustical and other forms of propagated signals (e.g., carrier waves, infrared signals, digital signals, etc.

While the apparatus and method have been described in terms of what are presently considered to be the most practical and effective embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
a first entity allowing a grouping of a plurality of second entities to receive a listing;
the first entity receiving from a third entity content to generate a listing to be provided to the grouping; and
the first entity providing the listing to the grouping.

2. The method of claim 1, wherein at least one second entity is an individual.

3. The method of claim 2, wherein each second entity is identified by at least one data point.

4. The method of claim 3, wherein the at least one data point comprises a fee to be paid to the second entity for having the listing provided by the first entity.

5. The method of claim 4, further comprising the first entity billing the third entity for generating and providing the listing to the second entity; and
wherein each second entity receives the fee to be paid for receiving the listing from the billing.

6. The method of claim 4, wherein the at least one data point further comprises demographic information.

7. The method of claim 6, wherein the first entity provides the demographic information to the third entity to allow the third entity to have the listing provided to only second entities that meet a set of demographic requirements.

8. The method of claim 1, wherein the grouping of second entities to receive a listing is defined by a set of demographics, wherein demographic data from which the demographics are determined is provided to the first entity by each second entity.

9. The method of claim 8, wherein the demographic data further comprises a fee to be paid to the second entity for receiving the listing.

10. The method of claim 9, further comprising the first entity billing the third entity for generating and providing the listing to the second entity; and
wherein each second entity receives the fee to be paid for receiving the listing from the billing.

11. The method of claim 1, further comprising the first entity receiving from the third entity content to generate a listing to be provided to at least one fourth entity.

12. The method of claim 11, wherein the fourth entity comprises at least one set of second entities different from the grouping.

13. The method of claim 1, further comprising the first entity billing the third entity for generating and providing the listing to the second entity.

14. The method of claim 13, wherein the first entity provides a portion of the billing to an owner of the grouping.

15. The method of claim 13, wherein the first entity provides a portion of the billing to at least one second entity.

16. The method of claim 15, wherein the portion of the billing each second entity is determined by the second entity.

17. The method of claim 15, wherein the first entity provides a portion of the billing to an owner of the grouping.

18. A method comprising:
a first entity collecting data from a plurality of second entities, the data comprising at least a fee to be paid to the second entity for receiving a listing from a third entity;
the first entity allowing the third entity to generate a grouping based at least in part on the data;
the first entity receiving from the third entity content to generate a listing to be provided to the grouping;
the first entity providing the listing to the grouping;
the first entity billing the third entity for allowing the third entity to generate the grouping, generating the listing, and providing the listing to the grouping; and
providing for each second entity the fee to be paid the second entity for receiving the listing from the third entity.

19. The method of claim 18, wherein the first entity billing is the sum of the fee to be paid to each second entity of the grouping plus a fee retained by the first entity.

20. A system comprising:
a first unit to have a first entity collect data from a plurality of second entities, the data comprising at least a fee to be paid to the second entity to receive a listing from a third entity;
a second unit to have the first entity support the third entity to generate a grouping based at least in part on the data;
a third unit to have the first entity receive from the third entity content to generate a listing to be provided to the grouping;
a fourth unit to have the first entity provide the listing to the grouping;
a fifth unit to have the first entity bill the third entity for supporting the third entity to generate the grouping, generate the listing, and provide the listing to the grouping; and
a sixth unit to provide for each second entity, the fee to be paid to the second entity for receiving the listing from the third entity.

21. A machine-readable medium having stored thereon a set of instructions which when executed perform a method comprising:
a first entity collecting data from a plurality of second entities, the data comprising at least a fee to be paid to the second entity for receiving a listing from a third entity;
the first entity allowing the third entity to generate a grouping based at least in part on the data;
the first entity receiving from the third entity content to generate a listing to be provided to the grouping;
the first entity providing the listing to the grouping;
the first entity billing the third entity for allowing the third entity to generate the grouping, generating the listing, and providing the listing to the grouping; and
providing for each second entity the fee to be paid the second entity for receiving the listing from the third entity.
